(19) United States
(12) Patent Application Publication
(10) Pub. No.: US 2013/0262583 A1
(43) Pub. Date: Oct. 3, 2013

(54) SYSTEM AND METHOD FOR NAMESPACE RESOLUTION IN PEER TO PEER NETWORKS

(71) Applicant: AYLUS NETWORKS, INC., Westford, MA (US)

(72) Inventor: Shamim A. Naqvi, Morristown, NJ (US)

(73) Assignee: Aylus Networks, Inc., Westford, MA (US)

(21) Appl. No.: 13/852,993

(22) Filed: Mar. 28, 2013

Related U.S. Application Data
(60) Provisional application No. 61/616,564, filed on Mar. 28, 2012.

(51) Int. Cl. H04L 29/06

(52) U.S. Cl. CPC H04L 65/403
USPC 709/204

(57) ABSTRACT

A system and method is provided for using information provided by a user or created by a server to create secondary registrations in multiple peer to peer communication networks in such a manner as to enable the user to gain visibility and communication access to subscribers on any of the various and multiple networks through a single login to a preferred network. Moreover, the user may gain the requisite access to subscribers on the multiplicity of networks by accessing them from any preferred network. Thus any one of several networks may be used to gain preferred access for communication ease and simplicity.

### STATEMENT OF RELATED APPLICATIONS

This application claims the benefit under 35 U.S.C. §119(e) of U.S. Provisional Application No. 61/616,564, filed Mar. 28, 2012 entitled “SYSTEM AND METHOD FOR NAMESPACE RESOLUTION IN PEER TO PEER NETWORKS”. The application is incorporated by reference herein in its entirety.

This application is also related to the following U.S. patent applications: U.S. patent application Ser. No. 11/166,406, filed Jun. 24, 2005, now U.S. Pat. No. 7,672,297; U.S. patent application Ser. No. 11/166,407, filed Jun. 24, 2005, now U.S. Pat. No. 7,792,528; U.S. patent application Ser. No. 11/166,456, filed Jun. 24, 2005, now U.S. Pat. No. 7,864,936; U.S. patent application Ser. No. 11/166,470, filed Jun. 24, 2005, now U.S. Pat. No. 7,561,535; U.S. patent application Ser. No. 11/282,924, filed Nov. 18, 2005, now abandoned; U.S. patent application Ser. No. 11/370,594, filed Mar. 8, 2006, now abandoned; U.S. patent application Ser. No. 11/370,793, filed Mar. 8, 2006, now U.S. Pat. No. 7,724,753; U.S. patent application Ser. No. 11/504,896, filed Aug. 16, 2006, pending; U.S. patent application Ser. No. 11/709,469, filed Feb. 22, 2007, pending; U.S. patent application Ser. No. 11/767,354, filed Jun. 22, 2007, pending; U.S. patent application Ser. No. 11/787,635, filed Apr. 17, 2007, now U.S. Pat. No. 7,856,226; U.S. patent application Ser. No. 12/050,765, filed Mar. 18, 2008, pending; U.S. patent application Ser. No. 12/104,995, filed Apr. 17, 2008, pending; and U.S. application Ser. No. 12/105,051, filed Apr. 17, 2008, pending, each application incorporated herewith in it entirety.

### FIELD OF THE INVENTION

The present disclosure relates generally to communications in peer to peer works by allowing a subscriber to simultaneously be registered or logged in a multiplicity of networks, receive and send communications in said networks, without necessitating or imposing any changes upon the individual networks, and, further, without restricting the use of any one such network in a preferential manner.

### BACKGROUND

Peer to peer networks are being increasingly used by subscribers to share information in real time, i.e., they are fast becoming real-time communication networks. In addition to the real-time support of information sharing, peer to peer networks allow subscribers to repose more trust in the shared information because it comes from “friends” or “buddies.” However, a subscriber's friends or buddies may frequent or prefer a multiplicity of networks so the subscriber is constrained to visit, log in, or “register” in all such networks. This process can be cumbersome and impractical since multiple identities have to be managed and maintained.

Prior art addresses this problem by allowing a subscriber to maintain a “master” or “primary” registration that in turn controls a number of secondary registrations. A subscriber is then only required to register with a primary registration holding entity that in turn maintains secondary registrations with a multiplicity of peer to peer networks. Information shared in any of these networks is then tunneled to the primary entity and, hence, becomes available to the subscriber.

However, prior art fails to address significant problems stemming from the hierarchical control implicit in the primary-secondary information flow. More concretely, whereas a primary registration holding entity is aware of all secondary registration holding entities, the converse is not true. An immediate consequence of this hierarchical control is that a subscriber, who registers himself at a first secondary entity and wishes to communicate with another subscriber at a second secondary entity, is unable to do so because the first secondary entity in principle is unaware of the second secondary entity.

In simpler terms, the primary registration holding entity is pre-designated and fixed. Viewed as a network of networks, the primary network controls a multiplicity of secondary networks in a hierarchical structure, with the “root” of the hierarchy having “visibility” to all the secondary entities (sub-nodes of the hierarchy). A subscriber who wishes to have visibility to all sub-nodes is required to physically login at the root node of the hierarchy.

Thus, it is a requirement of the primary-secondary control facilities provided by prior art that a subscriber, wishing to be in communication with a multiplicity of peer to peer networks, must register with the primary registration holding entity.

This requirement itself may be cumbersome. In certain cases a subscriber may choose to register with a particular peer to peer network because of reasons of economy, convenience, availability or features provided by a particular service provider.

In a preferred embodiment of this disclosure a subscriber is not constrained to register with a pre-designated primary registration holding entity. The disclosure allows a subscriber to register with any single network, i.e., registration holding entity, and yet maintain communications with and awareness of subscribers in other peer to peer networks. In other words, a subscriber may choose any network from amongst a multiplicity of networks to serve as his primary registration holder by making a choice or by simply logging in to one such network. Thus, the designation of a primary network becomes dynamic in the sense that it may change over time.

The preferred embodiment allows the hierarchical control structure of primary and secondary registrations to be rooted at any entity in a dynamic fashion and not limited to a certain pre-designated and pre-determined entity.

The practical advantage of this disclosure is to allow subscribers to use any personally preferred network service as their primary registration holding entity and maintains communication contact with “friends” and “buddies” in other networks.

As communication evolves from voice and text to multimedia it is becoming obvious that peer to peer networks will support sharing of real-time multimedia information such as video calls. Multimedia communication systems use many different types of coding systems for video and multimedia information and also employ different types of control and signaling protocols.

In the primary-secondary hierarchical control structure of registrations, it is known a priori that all signaling and media coding schemes are to be resolved with respect to the primary entity. If the primary-secondary relationship may be altered dynamically then such resolutions can only be known a posteriori. Such dynamically changing name spaces require changing call flows dynamically to allow end to end completion of real-time communication sessions.

Therefore, the present disclosure allows dynamic adaptation of media content based on the network the subscriber chooses to login to as his primary registration holding entity. In certain use cases such a choice can be dictated by economic or performance reasons if, for instance, a certain network technology affords preferential treatment to certain types of media, coverage availability, business relationships, billing discounts, etc.

### BRIEF DESCRIPTION OF THE DRAWINGS

FIG. 1 shows a hierarchical relationship among three networks to which subscribers may be registered.

FIG. 2 shows four different networks in which a subscriber may be registered.

FIG. 3 shows the four different networks of FIG. 2 in which the subscriber chooses one of the networks as a home network in which he or she has a home registration.

FIG. 4 shows a proxy client being associated with each of the four different networks of FIG. 2.

FIGS. 5-6 illustrate aspects of the invention using the four different networks of FIG. 2.

FIGS. 7A-7B is a flowchart illustrating one example of the present disclosure.

FIG. 8 shows one example of a system that may be employed to implement various aspects of the invention.

### DETAILED DESCRIPTION

In modern times, communicating information has become an extremely valuable commodity. Before the widespread use of computers, people commonly relied on television, radio, and periodicals such as newspapers as a main source of information about topics of all kinds Even back then, the reliability of information that a person received from these sources was dependent upon the source of the information. Certain newspapers and magazines were considered more reliable and trustworthy. Within such establishments certain reporters and sources were considered more reliable and the information that they provided was deemed to be trust worthier. A generation grew up trusting Walter Cronkite and his newscasts.

With the widespread use of computer technology, particularly as it relates to the web, people now have easy access to seemingly unlimited amounts of information concerning any topic. People can now use the web to quickly learn about any topic they choose. If a person wants to use information found on the web for future reference, he or she may save its Internet address or bookmark its web page.

However, the currency of information on web pages is debatable. Many pages are updated infrequently or only at certain times. A subscriber wishing to know a recent result or piece of information has no option but to wait until the web page author updates the requisite information. Moreover, not all web pages are considered equally trustworthy or reliable.

An important development in parallel to the web is that of peer to peer networks that generally allow online subscribers to share information through real-time communications or messaging. In these applications a subscriber may posit a question and it may elicit responses from any number of his “friends” or “buddies.”

Peer to peer networks and applications come in many guises. Some support real-time communications, some support messaging in which the questions and responses may occur over an extended period of time, etc. In certain embodiments a message may be posted for all “friends” or “buddies” to read when they register or login to the network.

A significant feature of all peer to peer networks is the requirement of a subscriber to register in the network in order to receive the service. A subscriber needs to be registered in the network in order to receive service. It is also the case that many peer to peer networks exist so that a subscriber may have to register in many networks, i.e., maintain credentials in all potential networks. This may be impractical or cumbersome for many subscribers. In this disclosure the words “register” and “login” are used as synonyms.

Prior art has provided solutions to this problem by allowing a subscriber to create a single registration identity that in turn controls multiple secondary identities. The idea is that a subscriber registers with a single network service, which in turn allows and maintains multiple secondary registrations in other networks. Messages and communications in the other networks are then tunneled back and forth to the subscriber. In a certain sense the subscriber maintains a “master” registration that controls multiple “secondary” registrations, one for each network.

As an example of prior art, the JABBER service allows a subscriber to maintain multiple registrations in instant messaging networks. By using JABBER a subscriber may be logged in to several instant messaging networks simultaneously and may send and receive instant messages from his “contacts” in any of the networks in which he is registered.

As another example, in telecommunication networks such as IMS a third-party registration mechanism is provided that allows a user endpoint (UE) to register with a S-CSCF (Serving Call State Control Function). The S-CSCF then may initiate registrations with a multiplicity of Application servers (AS) that in turn provide services to the UE.

However, prior art has failed in teaching a complete solution to this problem in that the control of registrations is unidirectional. In JABBER, the control of registrations is from JABBER to the individual networks. In IMS, the control of registrations flows from the S-CSCF to the AS. Using master-slave terminology or primary-secondary terminology, it can be stated that JABBER and S-CSCF are the master and primary registration holders, whereas the individual network entities or AS are the slave or secondary registration holders. It can be said that the relationship between the primary registration holder and the secondary relationship holders is strictly hierarchical.

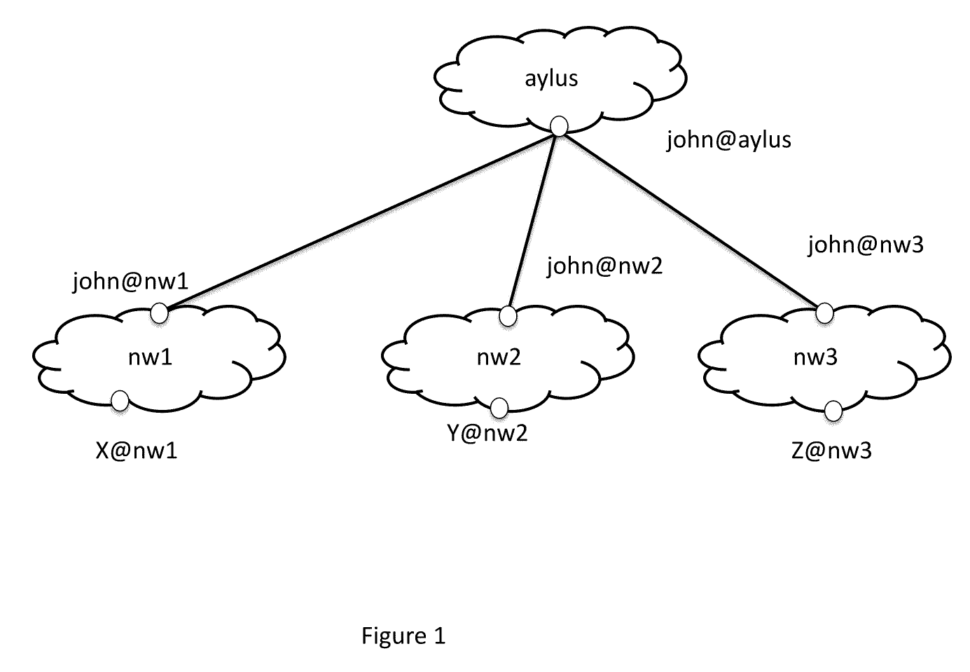

An immediate corollary of the hierarchical relationship between the primary and secondary registration entities is that whereas the primary registration holder “sees” or is “aware” of all secondary registrations, a “secondary” registration holding entity is unaware of all other registrations. Consider, by way of example, a situation in which two registrations holding entities may be “invisible” to each other, i.e., they may not be able to resolve names (addresses) of each other. Such a situation is depicted in FIG. 1 that shows three networks 1, 2 and 3 with subscribers X, Y and Z respectively. Each subscriber may, in principle, communicate with any other subscriber on the same network, i.e., has the capability to resolve the names of any subscribers in that network. Now, consider a subscriber John who is physically registered on a network “Aylus” that will be called the “default or home network.” Assume John wishes to communicate with his “friends” or “buddies” on networks 1, 2 and 3, and that these friends are “X”, “Y,” and “Z” respectively. Prior art allows him to create a primary entity “john@aylus,” and secondary entities “john@nw1” on network 1, “john@nw2” on network 2, and “john@nw3” on network 3. The lines connecting the entities in FIG. 1 are intended to show the hierarchical relationship between the primary registration (john@aylus) and the secondary registrations. It can be said that the lines show “awareness” or visibility.

As previously mentioned any subscribers in the same network may communicate with each other, e.g., X@nw1 and A@nw1, by resolving the names local to that network.

In FIG. 1 communications may occur between subscriber John physically registered as “john@aylus” and a subscriber “X@nw1” since “john@nw1” is a secondary registration of “john@aylus.” In a similar fashion, all communications between “Y@nw2” and “john@aylus” are achieved via “john@nw2.” Etc. A subscriber physically registered as “john@aylus” may see all communications from Y@nw2 and from X@nw1 because in essence “john@nw1” and “john@nw2” are proxies for “john@aylus.” It should be noted that “X@nw1” and “Y@nw2” are unable to communicate with each other in this arrangement since they cannot resolve the corresponding “names,” in the other subscriber's network as indicated by the control structure of the hierarchical namespace.

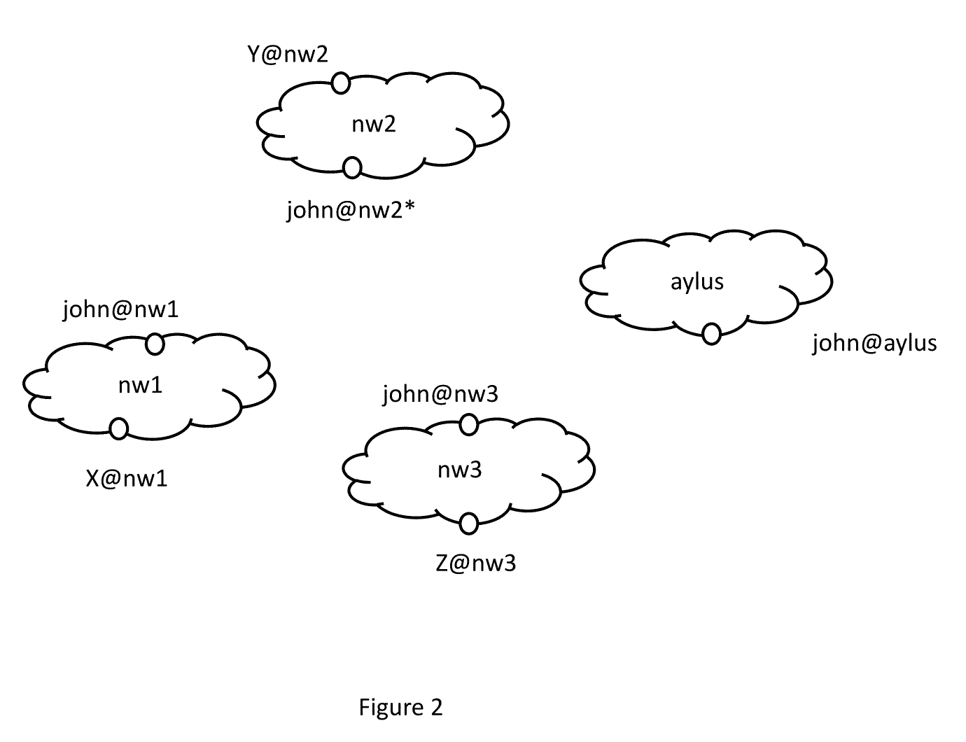

Consider now the situation depicted in FIG. 2. Once again, we have a primary registration john@aylus and the secondary registrations of john in nw1, nw2 and nw3. Assume that John is physically logged in to network 2 as john@nw2. We show this indicated by an asterisk against the corresponding registration. If the subscriber John is registered at network 2 (as user “john@nw2*”), as shown in FIG. 2, then the only names that John can resolve pertain to network 2. Thus, he may communicate with subscriber “Y@nw2” but not with subscribers “X@nw1” or “Z@nw3.”

One solution for this problem would be to create primary registrations for John not only at the default “aylus” network but at all networks, namely, nw1, nw2, and nw3. Each of these primary registrations would then have secondary registrations for John in each of the other networks. Thus, a primary registration for John at nw1 would have secondary registrations for John at nw2, nw3, and at network “aylus.” This would lead to an explosion in the number of registrations for any large peer to peer network and, since, such networks now typically boast of millions of subscribers, such a scheme would very quickly become unmanageable.

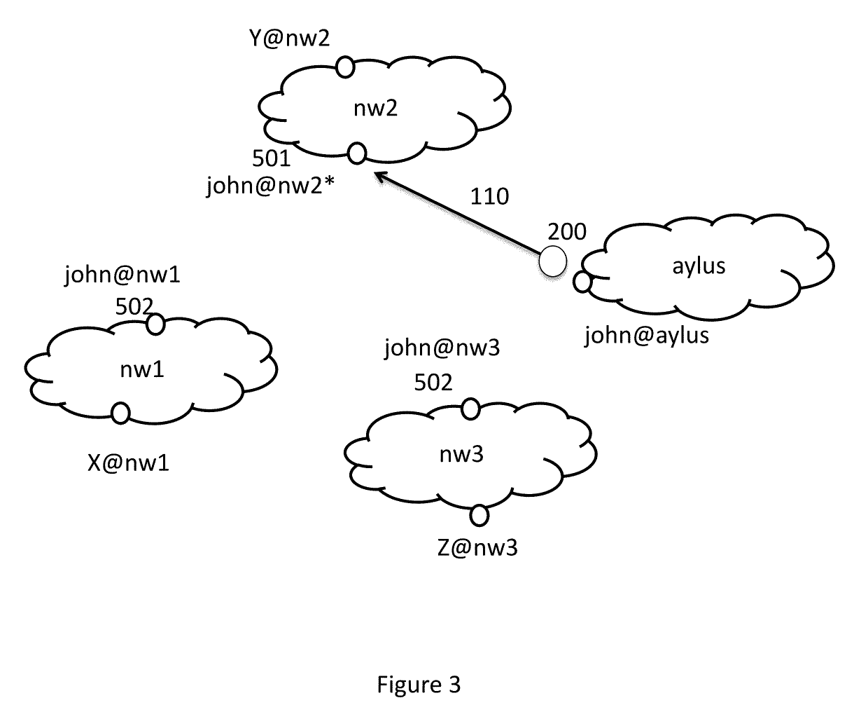

FIG. 3 depicts a different solution to the problem. Note that the primary registration of john@aylus causes secondary registrations at nw1, nw2 and nw3 respectively. This has been explained earlier with respect to prior art. In our invention we intend to eliminate the primacy role of certain registrations. Hence, we will refer to a registration explicitly chosen or stated by a user as his “home” registration. In FIG. 3 we assume that john@aylus is the home registration.

FIG. 3 also shows two new elements depicted as “circle” 200 and the directed arrow 110. The intended functionality of circle 200 is to tunnel all communications arriving at the “aylus” network for John's primary registration john@aylus to a pre-configured address. In this example, that address is “john@nw2” since John is physically logged in at that network. As will be explained later, the object “circle” 200 will be called a Routing Client (RC) and the address where the subscriber is physically logged in will be called the Control Point (CP).

We now consider the case of john@nw2 wishing to communicate or establish communications. Two cases need to be explained. First, john@nw2 may wish to communicate with a local “name” such as Y@nw2. As explained earlier, prior art teaches how to resolve local names.

Secondly, john@nw2 may wish to communicate with a non-local name such as Z@nw3 that by definition is not resolvable in network nw2. In this case we propose that CP 500 appeal to its RC 200 for a resolution. Since RC 200 is co-defined with home registration that in turn has a proxy john@nw3 503, RC 500 may route john@nw2's said appeal to the proxy john@nw3 that by definition can resolve the name Z@nw3 as it is a local name.

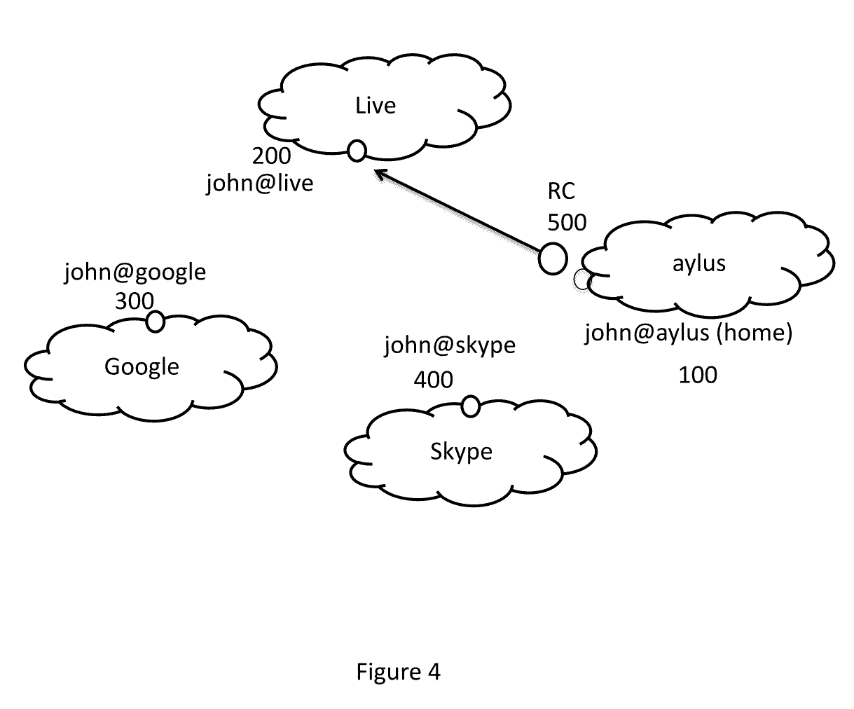

FIG. 4 shows an example of proxy clients 200, 300 and 400 at networks Live, Google and Skype respectively, defined for a subscriber john 100 homed at aylus network.

When a subscriber logs in to a network, other than his home network, and said network has a proxy client defined for him, his proxy client is marked or labeled as “active”. (This was also indicated in FIG. 3 by the asterisk on john@nw2 501.)

As will be known to practitioners skilled in the art, resolving names in a network involves making routing decisions. Thus, resolving a name such as xyz@skype.com involves deciding how to route incoming traffic to reach the address xyz@skype.com. We will now describe computer programs containing custom logic and memory to carry out specialized routing functions. These programs will be called CA (customized agent) logic.

We will now describe CA logic in more detail. CA logic consists of two components: (1) a proxy client (PC), and (2) routing client (RC). The function of PC is to assume a given name, i.e., a given network address, and respond to messages and interactions conforming to the name. Such a given network name will correspond to a network address. For example, a proxy client may be defined for the Skype network and given the name xyz@skype.com. Such a proxy client then is assumed to take on the functionality and functional conformance of a Skype client with the name xyz@skype.com. In essence there is no functional difference between the proxy client xyz@skype.com and the Skype name xyz@skype.com. Thus, if a proxy client receives an incoming text message addressed to it, it displays the text message as any other Skype client. As another example, proxy clients may take information and send it to other Skype clients, i.e., proxy clients may route outgoing traffic to other Skype clients.

The Routing Client (RC) logic differs from the logic of the PC. A RC is associated with a particular “homed” subscriber. For example, in FIG. 4, we may associate RC 500 with john@aylus 100. A RC accepts requests from an active PC and routes or forwards said request to another PC. For example, in FIG. 4, RC 500 may accept requests from active PC 200 and route them to PC 400.

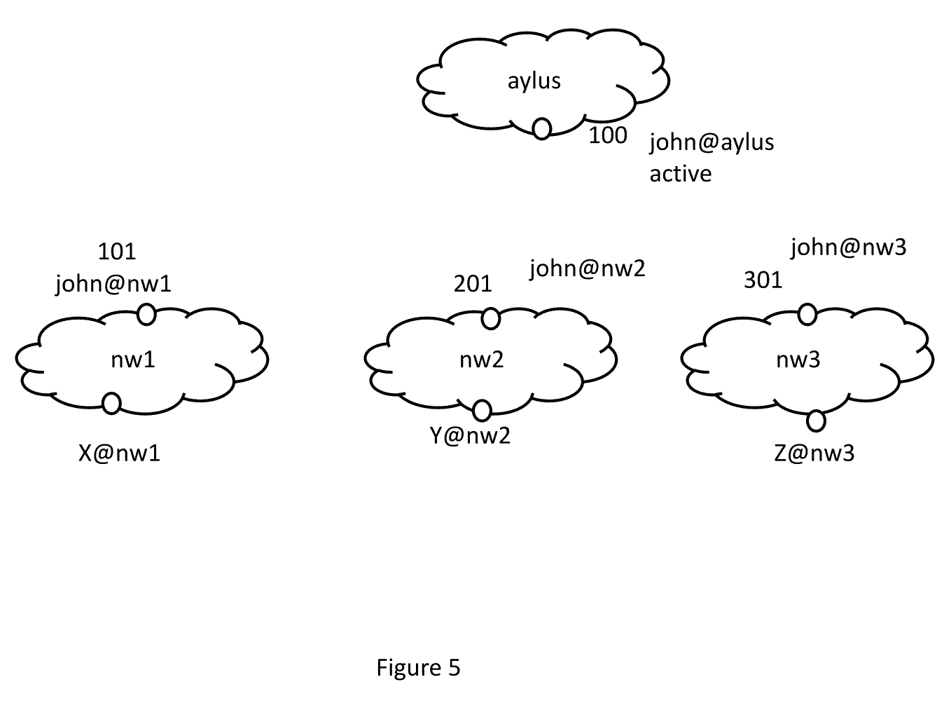

We now describe the operation of the exemplary embodiment of our invention with reference to previously stated examples. Consider FIG. 5. It is intended to show the situation depicted in FIG. 1. Subscriber “john” is logged into his home network “aylus” and his registration status is thus marked as “active” 100. He has proxy clients PC 101, PC 201 and PC 301 defined at networks nw1, nw2 and nw3 respectively. Local communications at nw1, nw2 and nw3 are possible since the local proxies act on behalf of the active proxy.

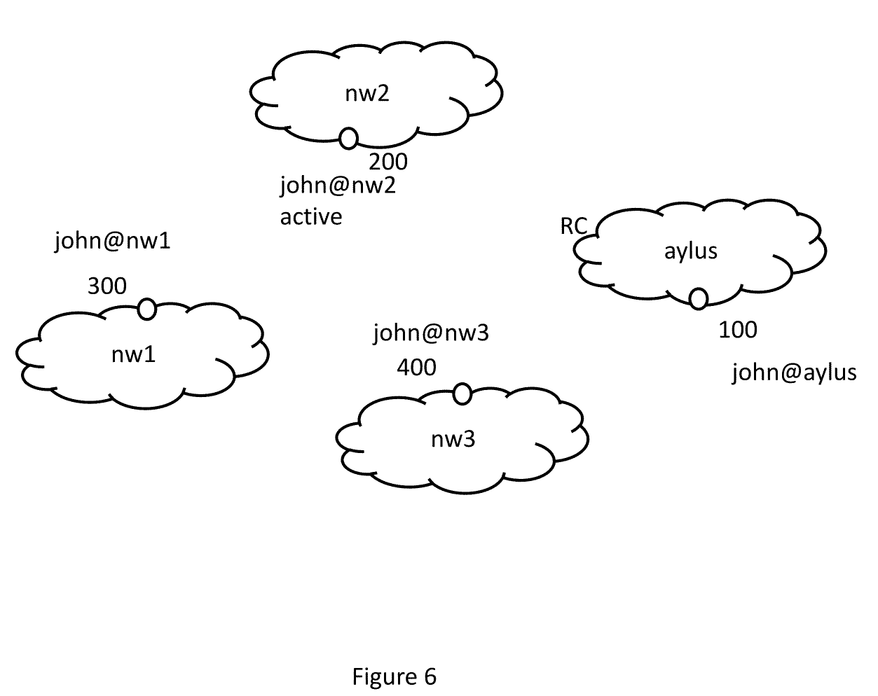

Now consider FIG. 6 wherein “john” is logged in to nw2 and hence marked as “active” 200. Note that RC 100 is defined and associated with the active registration 200 because nw2 is not a home network of “john”. Local communications between john@nw1 and X@nw1 are now possible (despite the fact that “john” is actually logged in at network nw2) because proxy client PC 300 acts as a proxy for john@aylus 100 which in turn using the RC 100 routes to john@nw2 active 200.

We now define additional functionalities for the proxy and routing clients PC and RC. As mentioned earlier, peer to peer networks are evolving to support multimedia communications. Thus, video, voice and text may be combined in different ways and constitute a message that is communicated across networks and entities. However, as is known and practiced today, a network may use its own media formats for encoding, rating and managing content. There is thus a need for Inter-Working Functions (IWF) across different media formats and appropriate IWFs may need to be invoked as messages traverse across network boundaries. We propose carrying such media annotated messages in signaling and other control structures and protocols within PC and RC communications.

As an alternative implementation of our preferred embodiment, we propose that the proxy and routing clients be implemented, i.e., the CA logic be implemented as control logic, in a Push Proxy Gateway (PPG) within a WAP gateway complex. As will be known to skilled practitioners in the art, a WAP gateway and the PPG route messages between mobile clients and servers and enable content to flow between said entities.

In a preferred embodiment of this disclosure, a system and apparatus designed to carry out the method described above, would consist of a server that first creates the default or home network and primary registration for a given subscriber. The said subscriber is then asked what secondary registrations he would like, perhaps from a displayed list of networks such as Skype, Yahoo, Google, etc. The said subscriber could be asked to provide pre-existing secondary registrations, or new registrations could be created by the aforementioned server, one secondary registration for each chosen network.

The aforementioned server then creates a proxy client for each chosen network (or selects a proxy client from a pre-determined list) and uses the information provided by the subscriber to register the proxy client on the corresponding chosen home network. It creates a RC (routing client) for every homed subscriber.

The subscriber is then asked to log in to a home network (or the default network). (In an alternative embodiment the system waits for the subscriber to log in.) When the user is logged in to a network, his registration status is marked as “active”. The RC client is set up to be in communication with the (proxy) client of the active subscriber.

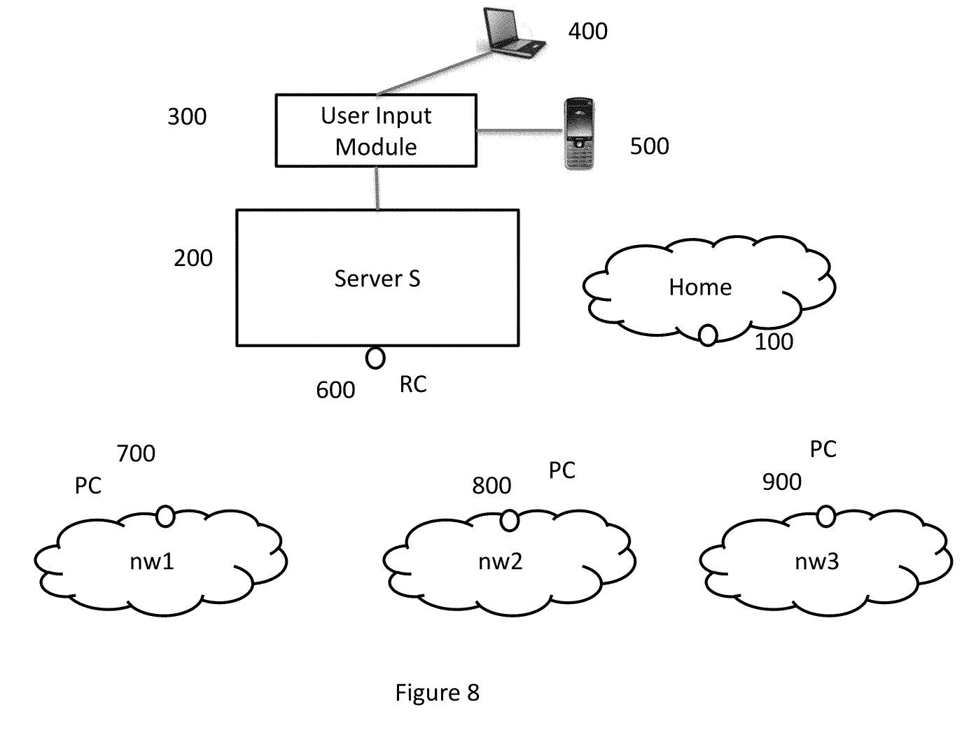

It is to be understood by practitioners in the art that the various proxy clients PC execute as computer programs in the aforementioned server (the default network). It is also to be understood that the RC similarly runs in the default network. In FIG. 8 we show the PC and RC on network 2 but that is for illustrative purposes only. All PC and RC are custom logic running in the default network on the aforementioned server.

For reasons of scalability, reliability and redundancy we may choose alternative embodiments that utilize principles of process migration and process distribution to run the PC and RC logics in a cluster of servers, with said cluster geographically distributed. In another embodiment the PC could be implemented as computer logic executing in virtual machine environments. These virtual machines may run in a plurality of servers, in clusters of servers, and server complexes.

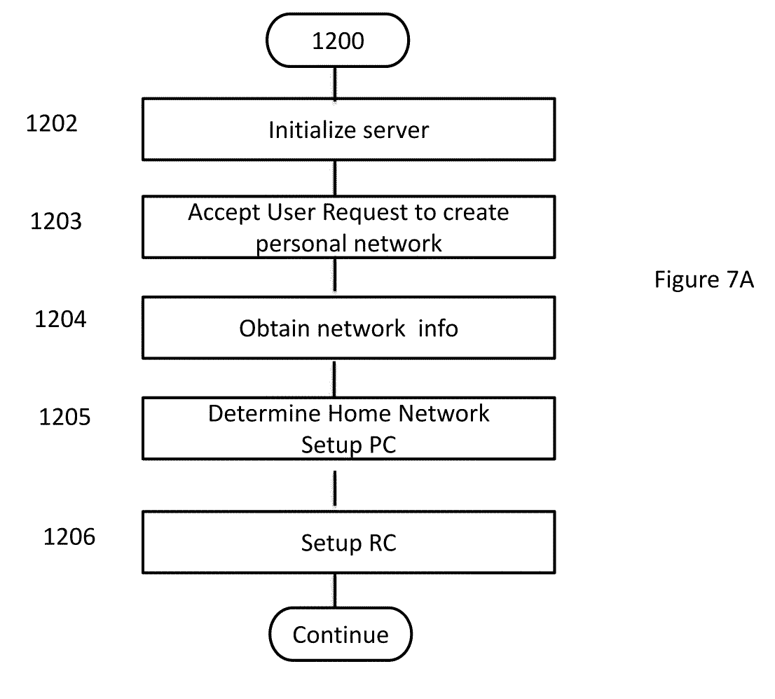

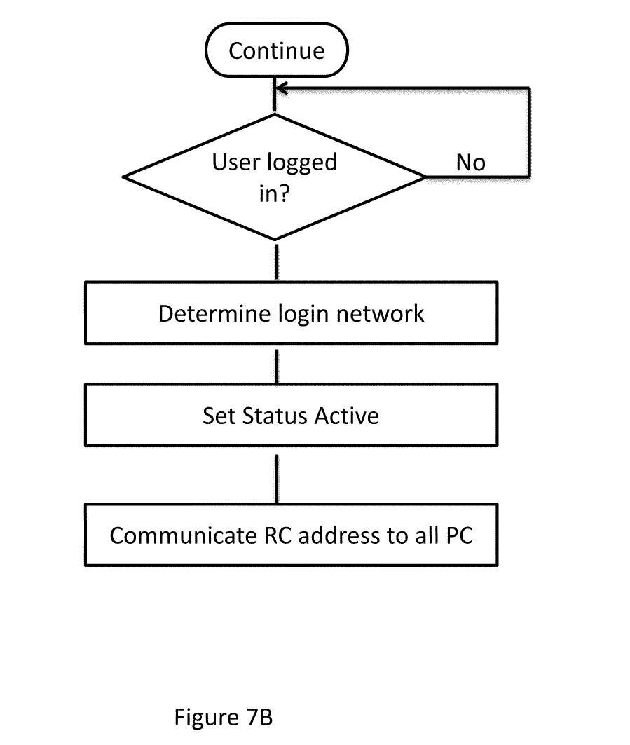

Turning now to FIGS. 7A-7B, a flowchart 1200 illustrating operation of embodiment of the present disclosure is shown. The particular arrangement of elements in the flowchart 1200 is not meant to imply a fixed order to the elements; embodiments can be practiced in any order that is practicable.

The aforementioned default network address is mapped to the server S.

At a process step 1202 the server S is initialized to start the personal network configuration process. A subscriber (user) request is accepted in process step 1203 to begin setting up the personal network. The user is asked to provide a table of home networks with login information in process step 1203. Or the user may request the server S to create the required credentials. The home network is determined from configuration data. The network address for RC is set up. In process step 1207 the process waits for the user to sign on to any of the previously named home networks and upon receiving such an indication the system sets the active variable. In process step 1210 the RC value is communicated to all proxy clients.

FIG. 8 shows an overall diagram of the preferred embodiment of the system and apparatus of the present disclosure. The server S 200 is connected to the home network 100. A user input module 300 is connected to S to enable a user to input configuration data to the server using a PC 400, mobile telephone 500, etc. Optionally, a user may login to the home network or any of the networks, network 1, network 2, or network 3, etc. Proxy clients and routing client 600 are created or configured based on user input at each of the networks, including the home network.

As is described in the preceding, the embodiment specifies that the user may in fact reside on any of the home or other networks.

The system includes a system bus or a plurality of system buses or network links to which various components are coupled and by which communication between the various components is accomplished.

One or more network interfaces enable communication over a network, such as a packet network like the Internet. The network interfaces may be implemented as wired or wireless network interfaces operating in accordance with, for example, one or more of the IEEE 802.11x standards and may also or alternatively implement other networking standards.

As noted above, embodiments of the present disclosure may be implemented in or in conjunction with a telephone, such as a wireless or cellular “smart” telephone. An exemplary cellular telephone including capabilities in accordance with an embodiment of the present disclosure could serve as the user input module and may be utilized to login to a home network or to the default network . In some embodiments, the cellular telephone may implement one or more elements of the methods disclosed herein, in particular the CP or the RP.

While specific implementations and hardware/software configurations for the mobile device and Server RP have been illustrated, it should be noted that other implementations and hardware configurations are possible and that no specific implementation or hardware/software configuration is needed. Thus, not all of the components illustrated may be needed for the mobile device or Server implementing the methods disclosed herein.

As used herein, whether in the above description or the following claims, the terms “comprising,” “including,” “carrying,” “having,” “containing,” “involving,” and the like are to be understood to be open-ended, that is, to mean including but not limited to. Only the transitional phrases “consisting of” and “consisting essentially of,” respectively, shall be considered exclusionary transitional phrases, as set forth, with respect to claims, in the United States Patent Office Manual of Patent Examining Procedures.

Any use of ordinal terms such as “first,” “second,” “third,” etc., in the claims to modify a claim element does not by itself connote any priority, precedence, or order of one claim element over another, or the temporal order in which acts of a method are performed. Rather, unless specifically stated otherwise, such ordinal terms are used merely as labels to distinguish one claim element having a certain name from another element having a same name (but for use of the ordinal term).

The above described embodiments are intended to illustrate the principles of the invention, but not to limit the scope of the invention. Various other embodiments and modifications to these preferred embodiments may be made by those skilled in the art without departing from the scope of the present invention.

1. A system and method for enabling communications between subscribers registered in a plurality of networks, wherein
each network preferentially maintains its own address space and user naming convention;
each user maintains one or more distinct user identities in a plurality of networks;
a user may be logged in one or a plurality of networks at any given time;
such that no user is required to choose or designate any one network as his primary network.

2. The system of claim 1 wherein communications consist of resolving addressing schemes from one network scheme to another network scheme.

3. The system of claim 1 wherein communications comprise multimedia objects.

4. The system of claim 1 wherein custom logic executes in a server environment with network connectivity to the plurality of communication networks.

5. The system of claim 1 wherein custom logic executes in a Push Proxy Gateway within a WAP complex.

6. The system of claim 1 wherein custom logic contains Proxy Client logic that tunnels communications from proxy clients to a Routing Client.

7. The system of claim 1 wherein custom logic contains Routing Client logic that routes communications to and from Proxy Clients to an Active Client.

8. The system of claim 1 wherein the custom logic of the Routing and Proxy Clients contains media formatting, coding and trans-rating Annotations.

9. The system of claim 1 wherein the networks are peer-to-peer networks.
